(19) United States
(12) Patent Application Publication
(10) Pub. No.: US 2009/0097856 A1
(43) Pub. Date: Apr. 16, 2009

(54) RECEIVER APPARATUS FOR USE IN OPTICAL SPACE TRANSMISSION SYSTEM

(76) Inventors: Hiroyuki Sasai, Osaka (JP); Tsutomu Niiho, Osaka (JP); Mariko Nakaso, Osaka (JP)

Correspondence Address: WENDEROTH, LIND & PONACK L.L.P., 2033 K. STREET, NW, SUITE 800, WASHINGTON, DC, 20006, US

(21) Appl. No.: 12/295,792

(22) PCT Filed: Apr. 3, 2007
(86) PCT No.: PCT/JP2007/057465

§ 371 Date: Oct. 2, 2008

(30) Foreign Application Priority Data
Apr. 4, 2006 (JP) 2006-103208

(51) Int. Cl. H04B 10/10

(52) U.S. Cl. 398/119

(57) ABSTRACT

There included are a plurality of light receiving sections (121, 122) for receiving a plurality of optical signals (R1, R2) and respectively converting the received optical signals to a plurality of electrical signals (r1, r2); a first calculating section (130) for subjecting the plurality of electrical signals (r1, r2) to a process of canceling interference components occurring due to propagation of the plurality of optical signals through space; and a second calculating section (140) for calculating, with respect to each of the plurality of electrical signals whose interference components have been canceled by the first calculating section, whether or not a distortion occurring due to optical beat interference has a value less than or equal to a predetermined permissible value.

### TECHNICAL FIELD

The present invention relates to a receiver apparatus for use in an optical transmission system in which light is used as a wirelessly transmitted signal and more particularly, to a receiver apparatus for use in an optical space transmission system in which optical signals emitted from a plurality of light transmitting sections are received.

### BACKGROUND ART

An optical space transmission system for transmitting a wirelessly transmitted signal which is light used through a free space (hereinafter, referred to as an optical signal) is used in a remote-control device or the like for conducting channel selection or the like on a household audio/video appliance or a television set for indoor use. A data transmission speed at which this remote-control device transmits an optical signal is comparatively low, approximately 1 Mbps or less. Therefore, even when an angle of divergence of a light beam containing an optical signal emitted by this remote-control device which is a transmitter apparatus is increased, a receiver apparatus can ensure a sufficient signal-to-noise power ratio (hereinafter, referred to as an SNR).

On the other hand, it has been desired to be capable of performing an optical space transmission at a high speed, approximately 100 Mbps to several Gbps, between a television monitor and a tuner. In order to realize such a high speed optical space transmission, it is required to increase a light receiving electric power of the receiver apparatus. As a method for increasing this light receiving electric power, there are the below-described methods.

In a first method, a transmitter apparatus decreases an angle of divergence of a light beam containing an optical signal and adjusts an optical axis of an emitted light beam such that the light beam accurately enters the receiver apparatus. In this case, since it is needed to maintain an accuracy of a position of the adjusted optical axis, a complicated optical axis adjustment mechanism is required.

In a second method, a plurality of light sources for emitting light beams containing optical signals and a plurality of photo-receivers for receiving these light beams are utilized. In this method, a signal to be transmitted is divided and these respective divided signals are simultaneously transmitted. This method is generally called an optical MIMO (Multiple Input Multiple Output). By employing this method, a speed at which the optical signals carried by the respective light beams are transmitted can be made low and a light receiving electric power of each of the respective photo-receivers can be reduced. Owing to this, the receiver apparatus allows a predetermined SNR (Signal to Noise Ratio) to be attained and a light receiving electric power of the whole receiver apparatus to be increased. Hereinafter, this second method will be described.

FIG. 9 is a diagram illustrating a conceptual configuration of a conventional optical space transmission employing the above-mentioned second method. As shown in FIG. 9, a transmitter apparatus 1023 comprises light sources 1101, 1103, and 1105. A receiver apparatus 1024 comprises light receiving elements 1102, 1104, and 1106, and a signal processing section 1022.

The light sources 1101, 1103, and 1105 respectively convert transmitting signals I₁ through Iₙ of n channels to optical signals and emit the optical signals. These emitted optical signals are emitted through, for example, a free space and transmitted to the light receiving elements 1102, 1104, and 1106. The light receiving elements 1102, 1104, and 1106 respectively convert the transmitted optical signals to light receiving signals S₁ through Sₘ which are electrical signals and input the light receiving signals S₁ through Sₘ to the signal processing section 1022. Note that here, m is a natural number greater than n. The signal processing section 1022 outputs receiving signals O₁ through Oₙ of the n channels whose number is the same as that of light sources.

Here, it is assumed that a matrix whose elements are the transmitting signals I₁ through Iₙ is I; a matrix whose elements are the light receiving signals S₁ through Sₘ inputted to the signal processing section 1022 is S; and a transfer factor matrix whose elements are transfer factors h₁₁ through hₘₙ, with which the optical signal are transferred from the light sources to the light receiving elements, is H. This allows the matrix I and the matrix S to be associated with each other by using the transfer factor matrix H and to be expressed by an equation S=H*I. Here, * is a sign representing a multiplication of the matrices. In addition, it is assumed that a matrix whose elements are the receiving signals O₁ through Oₙ outputted from the signal processing section 1022 is O; and a transfer factor matrix which indicates processing performed by the signal processing section 1022 is Φ. This allows the matrix O and the matrix S to be associated with each other by using the transfer factor matrix Φ and to be expressed by an equation O=Φ*S. From these two equations, an equation O=Φ*H*I is derived. By performing a process of diagonalizing a part [Φ*H] in the equation O=Φ*H*I, the signal processing section 1022 cancels spatial overlaps (which are, in a broad sense, interpreted as interference components occurring due to the propagation of the respective optical signals) of the respective optical signals transmitted through the space. As a result, the conventional receiver apparatus 1024 is capable of independently reproducing, from the respective optical signals, the receiving signals O₁ through Oₙ which correspond to the transmitting signals I₁ through Iₙ.

As described above, the conventional receiver apparatus allows a reduction in a light receiving electric power of each of the light receiving elements. Owing to this, the conventional receiver apparatus allows a predetermined SNR to be attained and a light receiving electric power to be increased. As a result, without decreasing an angle of divergence of a light beam outputted from each of the respective light sources and without precisely adjusting an optical axis direction of the light beam, a high-speed optical space transmission can be realized. Patent Document 1: Japanese Patent Application Laid-Open Publication No. 2005-6017 (Page 5 through 8, FIG. 1 and FIG. 2)

### DISCLOSURE OF THE INVENTION

### Problems to be Solved by the Invention

In the configuration of the above-described conventional receiver apparatus, however, when wave lengths of the optical signals outputted from the plurality of light sources are the same as one another or approximate to one another, there arises a problem that an optical beat interference noise (which is, in a broad sense, interpreted as a distortion occurring due to optical beat interference) occurring due to mutual interference of the optical signals exerts an influence. Because of this, it is required to use light sources which emit light beams having wave lengths which are different from one another, thereby leading to a problem that a management cost is required which is higher than that required when light sources which emit light beams having the same wave lengths as one another are used.

Therefore, an object of the present invention is to provide an optical space transmission apparatus in which an optical beat interference noise is reduced, whereby it is not required to use light sources which emit light beams having wave lengths which are different from one another.

### Solution to the Problems

The present invention is directed to a receiver apparatus, for use in an optical space transmission, operable to receive a plurality of optical signals which are converted from a plurality of transmission electrical signals and emitted through the space. To achieve the above-mentioned object, the receiver apparatus according to the present invention comprises: a plurality of light receiving sections for receiving the plurality of optical signals and respectively converting the received plurality of optical signals to a plurality of electrical signals; a first calculating section for subjecting the plurality of electrical signals to a process of canceling interference components occurring due to propagation of the plurality of optical signals through the space; and a second calculating section for calculating, with respect to each of the plurality of electrical signals whose interference components have been canceled by the first calculating section, whether or not a value of a distortion occurring due to optical beat interference is less than or equal to a predetermined permissible value.

In addition, it is preferable that when the value of the distortion occurring due to the optical beat interference is not less than or equal to the predetermined permissible value, the second calculating section further subjects each of the plurality of electrical signals, whose interference components have been canceled by the first calculating section, to a process of canceling the distortion occurring due to the optical beat interference.

Further, it is preferable that the second calculating section selects one optimum combination of a plurality of electrical signals from among one combination of the plurality of electrical signals obtained when the plurality of electrical signals are subjected to the process by the first calculating section and a plurality of combinations of a plurality of electrical signals obtained when the plurality of electrical signals obtained when the plurality of electrical signals are subjected to the process by the first calculating section are subjected to the process by the second calculating section and determines the one optimum combination of the plurality of electrical signals as the plurality of transmission electrical signals.

Still further, the first calculating section may cancel the interference components occurring due to the propagation by using propagation factors obtained by conducting a transmission path measurement and the second calculating section cancels the distortion occurring due to the optical beat interference by using values of optical beat interference components, which have been obtained by conducting an optical beat interference component measurement.

Still further, the optical beat interference components may be measured by performing, for all combinations of a pair of the light transmitting sections, an operation in which the plurality of the light receiving sections receive optical signals concurrently transmitted by any pair of the light transmitting sections among the plurality of light transmitting sections for transmitting the plurality of optical signals.

Still further, polarized waves of each two adjacent optical signals of the plurality of optical signals converted from the plurality of transmission electrical signals may be orthogonalized and when the value of the distortion occurring due to the optical beat interference is less than or equal to the predetermined permissible value, the second calculating section may output, as the plurality of transmission electrical signals, the plurality of electrical signals whose interference components have been canceled by the first calculating section.

The present invention is also directed to a reception method for use in an optical space transmission, in which a plurality of optical signals converted from a plurality of transmission electrical signals and emitted through the space are received. To achieve the above-mentioned object, the reception method for use in an optical space transmission, according to the present invention, comprises the steps of: receiving the plurality of optical signals and respectively converting the received optical signals to a plurality of electrical signals; canceling, with respect to the plurality of electrical signals, interference components occurring due to propagation of the plurality of optical signals through the space; and calculating, with respect to each of the plurality of electrical signals whose interference components have been canceled by the first calculating section, whether or not a value of a distortion occurring due to optical beat interference is less than or equal to a predetermined permissible value.

In addition, it is preferable that the reception method further comprises the step of, when the value of the distortion occurring due to the optical beat interference is not less than or equal to the predetermined permissible value, subjecting each of the plurality of electrical signals, whose interference components have been canceled, to a process of canceling the distortion occurring due to the optical beat interference.

Further, it is preferable that the reception method further comprises the step of selecting one optimum combination of a plurality of electrical signals from among one combination of the plurality of electrical signals which have been subjected to the process of canceling the interference components occurring due to the propagation and a plurality of combinations of a plurality of electrical signals which have been subjected to the process of canceling the distortion occurring due to the optical beat interference and determining the one optimum combination of the plurality of electrical signals as the plurality of transmission electrical signals.

Still further, at the step of canceling the interference components occurring due to the propagation, values of propagation factors, which have been obtained by conducting a transmission path measurement, may be used, and at the step of canceling the distortion occurring due to the optical beat interference, values of optical beat interference components, which have been obtained by conducting a optical beat interference component measurement, my be used.

Still further, the optical beat interference components may be measured by performing, for all combinations of a pair of the light transmitting sections, an operation in which the plurality of the light receiving sections receive optical signals concurrently transmitted by any pair of the light transmitting sections among the plurality of light transmitting sections for transmitting the plurality of optical signals.

Still further, polarized waves of each two adjacent optical signals of the plurality of optical signals converted from the plurality of transmission electrical signals may be orthogonalized and when the value of the distortion occurring due to the optical beat interference is less than or equal to the predetermined permissible value, the plurality of electrical signals whose interference components occurring due to the propagation have been canceled may be outputted as the plurality of transmission electrical signals.

The present invention is directed to a program executed by a receiver apparatus, for use in an optical space transmission, operable to receive a plurality of optical signals which are converted from a plurality of transmission electrical signals and emitted through the space. To achieve the above-mentioned object, the program according to the present invention comprises the steps of: receiving the plurality of optical signals and respectively converting the received plurality of optical signals to a plurality of electrical signals; subjecting the plurality of electrical signals to a process of canceling interference components occurring due to propagation of the plurality of optical signals through the space; and calculating, with respect to each of the plurality of electrical signals whose interference components have been canceled by the first calculating section, whether or not a value of distortion occurring due to optical beat interference is less than or equal to a predetermined permissible value.

### EFFECT OF THE INVENTION

As described above, according to the present invention, even when the wave lengths of the optical signals outputted from the plurality of light sources are the same as one another or approximate to one another, an influence of the optical beat interference noise can be reduced. Owing to this, when an optical space transmission is performed, it is not required to select light sources which emit light beams having wave lengths which are different from one another. Thus, a management cost can be made lower than that required when light sources which emit light beams having wave lengths which are different from one another are used.

### BRIEF DESCRIPTION OF THE DRAWINGS

FIG. 1 is a diagram illustrating a configuration of an optical space transmission system using a receiver apparatus according to an embodiment of the present invention.

FIG. 2 is a diagram showing conditions under which a transmission path measurement in a case where two light transmitting sections and two light receiving sections are used is conducted.

FIG. 3 is a diagram, for illustrative purposes, showing conditions under which a transmission path measurement in a case where four light transmitting sections and four light receiving sections are used is conducted and received light intensities of the respective light receiving sections.

FIG. 4 is a diagram showing conditions under which an optical beat interference component measurement in a case where two light transmitting sections and two light receiving sections are used is conducted.

FIG. 5 is a diagram, for illustrative purposes, showing conditions under which the optical beat interference component measurement in a case where four light transmitting sections and four light receiving sections are used is conducted and received light intensities of the respective light receiving sections.

FIG. 6 is a flowchart showing the transmission path measurement and the optical beat interference component measurement.

FIG. 7 is a flow chart showing operations performed when the receiver apparatus according to the embodiment of the present invention cancels spatial overlaps of transmitted optical signals and optical beat interference components.

FIG. 8 is a diagram showing an example of a configuration of a frame which the receiver apparatus according to the embodiment of the present invention receives.

FIG. 9 is a diagram illustrating a conceptual configuration of a receiver apparatus for use in a conventional optical space transmission.

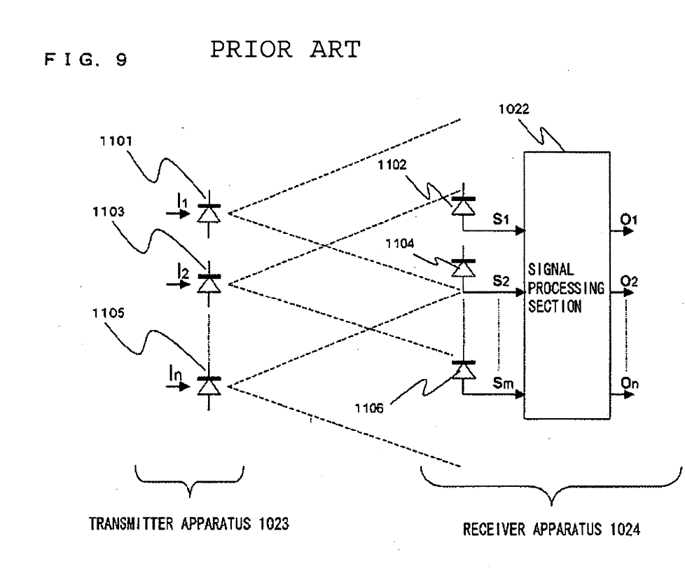

### DESCRIPTION OF THE REFERENCE CHARACTERS

111 first light transmitting section
112 second light transmitting section
113, 1023 transmitter apparatus
121 first light receiving section
122 second light receiving section
130 first calculating section
140 second calculating section
150, 1024 receiver apparatus
1101, 1103, 1105 light source
1102, 1104, 1106 light receiving element

### BEST MODE FOR CARRYING OUT THE INVENTION

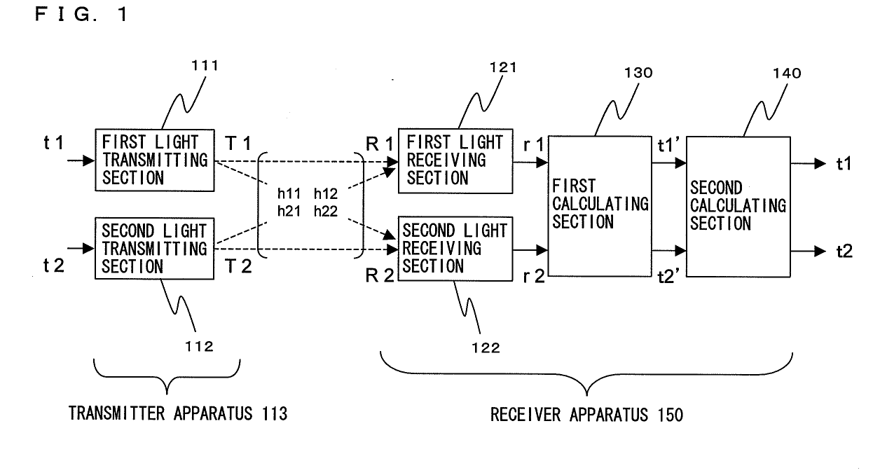

FIG. 1 is a diagram illustrating a configuration of an optical space transmission system using a receiver apparatus according to an embodiment of the present invention. As shown in FIG. 1, this optical space transmission system comprises a transmitter apparatus 113 and a receiver apparatus 150. The transmitter apparatus 113 includes a first light transmitting section 111 and a second light transmitting section 112. The receiver apparatus 150 includes a first light receiving section 121, a second light receiving section 122, a first calculating section 130, and a second calculating section 140. Note that although hereinafter, a case where two light transmitting sections and two light receiving sections are included respectively is mainly described, three or more light transmitting sections and three or more light receiving sections may be included respectively.

Hereinafter, operations of the transmitter apparatus 113 and the receiver apparatus 150 will be described. The first light transmitting section 111 receives an electrical signal t1 (hereinafter, referred to as a transmission electrical signal t1) having data to be transmitted. The second light transmitting section 112 receives an electrical signal t2 ((hereinafter, referred to as a transmission electrical signal t2) having data to be transmitted. The first light transmitting section 111 converts the transmission electrical signal t1 to an optical signal T1 (hereinafter, referred to as a transmission optical signal T1) having data to be transmitted and emits the converted optical signal T1 to the space. Similarly, the second light transmitting section 112 converts the transmission electrical signal t2 to an optical signal T2 ((hereinafter, referred to as a transmission optical signal T2) having data to be transmitted and emits the converted optical signal T2 to the space. At this time, the transmission optical signals T1 and T2 are emitted as light beams having angles of divergence. The most simple forms of the transmission electrical signals t1 and t2 are binary digital signals. Hereinafter, for illustrative purposes, forms of the transmission electrical signals t1 and t2 will be described as binary digital signals.

Here, it is assumed that an oscillatory frequency of the transmission optical signal T1 is ω1 and an oscillatory frequency of the transmission optical signal T2 is ω2; a phase noise of the transmission optical signal T1 is φ1 and a phase noise of the transmission optical signal T2 is φ2; and an optical electric power in a case where the transmission electrical signal t1 is “1” is P1 and an optical electric power in a case where the transmission electrical signal t2 is “1” is P2. When these are assumed, relationships of the transmission optical signals T1 and T2 and the transmission electrical signals t1 and t2 are expressed by the following equations (1) and (2).

T1=\sqrt{P1t1} cos(ω1t+Φ1) [Equation 1]

T2=\sqrt{P2t2} cos(ω2t+Φ2) [Equation 2]

Next, the first light receiving section 121 optically receives the emitted transmission optical signals T1 and T2 as a reception optical signal R1 through the space. Similarly, the second light receiving section 122 also optically receives the emitted transmission optical signals T1 and T2 as a reception optical signal R2 through the space.

Here, it is assumed that a propagation factor of the transmission optical signal T1 in a case where the transmission optical signal T1 is optically received by the first light receiving section 121 is h11; and a propagation factor of the transmission optical signal T1 in a case where the transmission optical signal T1 is optically received by the second light receiving section 122 is h21. Similarly, it is assumed that a propagation factor of the transmission optical signal T2 in a case where the transmission optical signal T2 is optically received by the first light receiving section 121 is h12; and a propagation factor of the transmission optical signal T2 in a case where the transmission optical signal T2 is optically received by the second light receiving section 122 is h22. When these are assumed, a relationship between the transmission optical signals T1 and T2 and the reception optical signals R1 and R2 is expressed by the following equation (3).

$$( \begin{matrix}R 1 \\ R 2\end{matrix} ) = ( \begin{matrix}h 11 & h 12 \\ h 21 & h 22\end{matrix} ) ( \begin{matrix}T 1 \\ T 2\end{matrix} ) \qquad [ Equation 3 ]$$

Next, the first light receiving section 121 converts the reception optical signal R1 to a reception electrical signal r1 by performing squared detection and outputs the reception electrical signal r1 to the first calculating section 130. Similarly, the second light receiving section 122 converts the reception optical signal R2 to a reception electrical signal r2 by performing the squared detection and outputs the reception electrical signal r2 to the first calculating section 130.

Here, it is assumed that a conversion efficiency at which the reception optical signal R1 is converted to the reception electrical signal r1 is b1; and a conversion efficiency at which the reception optical signal R2 is converted to the reception electrical signal r2 is b2. When these are assumed, relationships between the reception optical signals R1 and R2 and the reception electrical signals r1 and r2 are expressed by the following equations (4) and (5).

r1=b1R1² [Equation 4]

r2=b2R2² [Equation 5]

When the equations (1) through (5) are considered, relationships between the transmission electrical signals t1 and t2 and the reception electrical signals r1 and r2 are expressed by the following equations (6) and (7). Note that among components occurring when the squared detection is performed, the number of frequency components which can be extracted as the electrical signals are subject to restrictions by a response speed of the light receiving element.

$$\begin{matrix}\begin{matrix}r 1 = b 1 R {1}^{2} \\ = b 1 {( h 11 T 1 + h 12 T 2 )}^{2} \\ = b 1 [ \begin{matrix}h {11}^{2} T {1}^{2} + h {12}^{2} T {2}^{2} + h 11 h 12 cos \\ \{ ( ω 1 - ω 2 ) t + Φ 1 - Φ 2 \} \sqrt{P 1 t 1 P 2 t 2}\end{matrix} ] \\ = b 1 [ \begin{matrix}h {11}^{2} P 1 t 1 / 2 + h {12}^{2} P 2 t 2 / 2 + h 11 h 12 cos \\ \{ ( ω 1 - ω 2 ) t + Φ 1 - Φ 2 \} \sqrt{P 1 t 1 P 2 t 2}\end{matrix} ]\end{matrix} & [ Equation 6 ] \\ \begin{matrix}r 2 = b 2 R {2}^{2} \\ = b 2 {( h 21 T 1 + h 22 T 2 )}^{2} \\ = b 2 [ \begin{matrix}h {21}^{2} T {1}^{2} + h {22}^{2} T {2}^{2} + h 21 h 22 cos \\ \{ ( ω 1 - ω 2 ) t + Φ 1 - Φ 2 \} \sqrt{P 1 t 1 P 2 t 2}\end{matrix} ] \\ = b 2 [ \begin{matrix}h {21}^{2} P 1 t 1 / 2 + h {22}^{2} P 2 t 2 / 2 + h 21 h 22 cos \\ \{ ( ω 1 - ω 2 ) t + Φ 1 - Φ 2 \} \sqrt{P 1 t 1 P 2 t 2}\end{matrix} ]\end{matrix} & \{ Equation 7 ]\end{matrix}$$

Here, the equations (6) and (7) are arranged to be the following equations by replacing the respective terms in the equations (6) and (7) with the following k11, k12, k21, k22, n1, and n2 (equations (8) through (11)).

k11=b1h11²P1/2,k12=b1h12²P2/2 [Equation 8]

k21=b2h21²P1/2,k22=b2h22²P2/2 [Equation 9]

n1=b1h11h12 cos{(Φ1−Φ2)t+Φ1−Φ2}\sqrt{P1t1P2t2} [Equation 10]

n2=b2h21h22 cos{(ω1−ω2)t+Φ1−Φ2}\sqrt{P1t1P2t2} [Equation 11]

By arranging these, a relationship between the transmission electrical signals t1 and t2 and the reception electrical signals r1 and r2 is expressed by the following equation (12).

$$( \begin{matrix}r 1 \\ r 2\end{matrix} ) = ( \begin{matrix}k 11 & k 12 \\ k 21 & k 22\end{matrix} ) ( \begin{matrix}t 1 \\ t 2\end{matrix} ) + ( \begin{matrix}n 1 \\ n 2\end{matrix} ) \qquad [ Equation 12 ]$$

Then, the equation (12) can be modified into the following equation (13).

$$( \begin{matrix}t 1 \\ t 2\end{matrix} ) = {( \begin{matrix}k 11 & k 12 \\ k 21 & k 22\end{matrix} )}^{- 1} \{ ( \begin{matrix}r 1 \\ r 2\end{matrix} ) - ( \begin{matrix}n 1 \\ n 2\end{matrix} ) \} \qquad [ Equation 13 ]$$

Here, n1 and n2 in the equation (13) are optical beat interference components (which are, in abroad sense, interpreted as distortions occurring due to optical beat interference). The optical beat interference components are output signal components obtained when beats of frequencies occurring when a plurality of light waves whose frequencies are approximate to one another overlap are detected by an optical receiver or the like. These optical beat interference components are noise components. As shown by the equations (10) and (11), n1 and n2 which are these noise components both contain the transmission electrical signals t1 and t2. Accordingly, electric powers of these n1 and n2 change depending on both of the transmission electrical signals t1 and t2. Owing to this, when values of the transmission electrical signals t1 and t2 are both “1”, n1 and n2 which are the noise components occur. When either of the values of the transmission electrical signals t1 and t2 is “0”, values of the optical beat interference components n1 and n2 are “0” and therefore, n1 and n2 which are the noise components do not occur in principle. As described above, when the two transmission optical signals T1 and T2 are concurrently emitted, the optical beat interference components n1 and n2 occur. In a case where the number of the light transmitting sections and the number of the light receiving sections are respectively three or more, the optical beat interference components occur when two or more transmission optical signals are concurrently emitted.

Hereinafter, in consideration of these optical beat interference components, operations to reproduce the transmission electrical signals t1 and t2 will be described. As shown by the equation (13), the transmission electrical signals t1 and t2 can be obtained from the reception electrical signals r1 and r2 by obtaining an inverse matrix of a matrix having elements k11, k12, k21, and k22. However, as described above, when both of the values of the transmission electrical signals t1 and t2 are “1”, the optical beat interference components n1 and n2 exert an influence. Therefore, as described later, the first calculating section 130 performs a calculation 1 and thereafter, the second calculating section 140 performs a calculation 2, whereby the receiver apparatus 150 cancels spatial overlaps (which are, in a broad sense, interpreted as interference components occurring due to the propagation of the respective optical signals through the space) of the respective optical signals transmitted through the space, cancels the optical beat interference components n1 and n2, and reproduces the transmission electrical signals t1 and t2.

In order to perform communications by implementing the above-mentioned calculation 1 and calculation 2, the optical space transmission system using the receiver apparatus according to the present invention conducts a transmission path measurement prior to starting the communications by using the conventional technology. For example, because in a case where the communications are performed by using the receiver apparatus 150 which is mobile, a positional relationship between the transmitter apparatus 113 and the receiver apparatus 150 changes, the transmission path measurement between the transmitter apparatus 113 and the receiver apparatus 150 is conducted, and thereafter, the communications are started. In a case where the communications are performed with the transmitter apparatus 113 and receiver apparatus 150 fixed in a building or the like, in principle, it is only required to conduct the transmission path measurement only when the transmitter apparatus 113 and receiver apparatus 150 are fixed therein. Here, the transmission path measurement in this case is to obtain the transfer factors h11, h12, h21, and h22 indicating differences between transmission and reception levels and propagation times resulting when the transmission optical signals T1 and T2 are transmitted from the first light transmitting section 111 and the second light transmitting section 112 to the first light receiving section 121 and the first light receiving section 122.

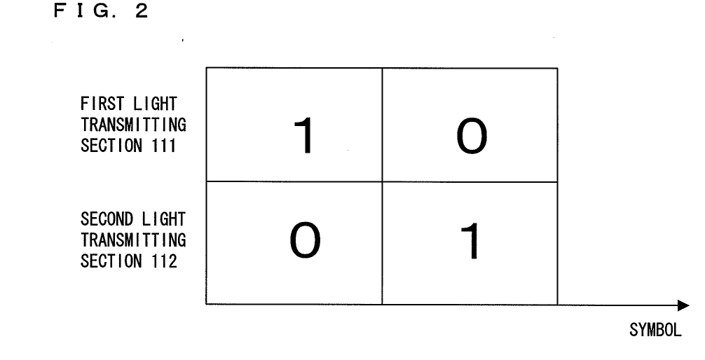

FIG. 2 is a diagram showing conditions under which the transmission path measurement in a case where two light transmitting sections and two light receiving sections are used is conducted. Hereinafter, a method for conducting the transmission path measurement will be described with reference to FIG. 2. As shown in FIG. 2, the first light transmitting section 111 first converts the transmission electrical signal t1, whose value is “1”, to the transmission optical signal T1 and transmits the transmission optical signal T1 to the first light receiving section 121 and the second light receiving section 122. Here, the second light transmitting section 112 does not transmit the transmission electrical signal t2. The transmission optical signal T1 propagates through the space and thereafter, is received as the reception optical signal R1 by the first light receiving section 121; and the transmission optical signal T1 propagates through the space and thereafter, is received as the reception optical signal R2 by the second light receiving section 122 (refer to FIG. 1). The first calculating section 130 determines the transfer factors h11 and h21 such that values of the transmission optical signal T1, the reception optical signal R1, and the reception optical signal R2 are the same as one another (refer to the equation (3)). Similarly, the second light transmitting section 112 converts the transmission electrical signal t2, whose value is “1”, to the transmission optical signal T2 and transmits the transmission optical signal T2 to the first light receiving section 121 and the second light receiving section 122. Here, the first light transmitting section 111 does not transmit the transmission optical signal T1 (refer to FIG. 2). The transmission optical signal T2 propagates through the space and thereafter, is received as the reception optical signal R1 by the first light receiving section 121; and the transmission optical signal T2 propagates through the space and thereafter, is received as the reception optical signal R2 by the second light receiving section 122 (refer to FIG. 1). The first calculating section 130 determines the transfer factors h12 and h22 such that values of the transmission optical signal T2, the reception optical signal R1, and the reception optical signal R2 are the same as one another (refer to the equation (3)). The above-described process enables the first calculating section 130 to obtain the transfer factors h11, h12, h21, and h22. Prior to starting the communications, the first calculating section 130 retains the obtained transfer factors h11, h12, h21, and h22.

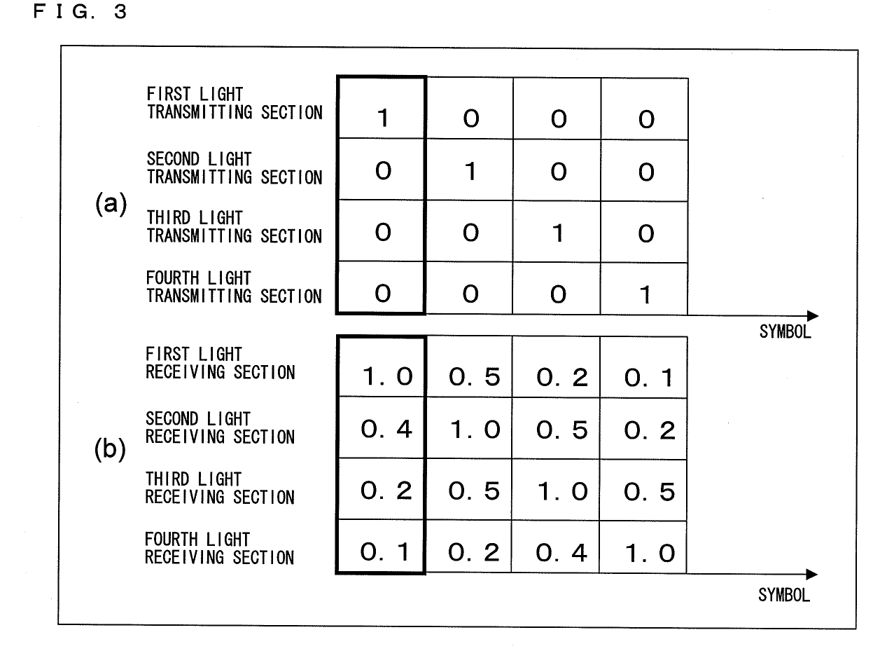

As conditions under which the transmission path measurement is conducted and as received light intensities of respective light receiving sections in a case where three or more light transmitting sections and three or more light receiving sections are used, for illustrative purposes, conditions under which a transmission path measurement is conducted and received light intensities of respective light receiving sections in a case where four light transmitting sections and four light receiving sections are used are shown in FIG. 3. As shown in (a) of FIG. 3, only any one of the light transmitting sections converts a transmission electrical signal, whose value is “1”, to a transmission optical signal and transmits the transmission optical signal to each of the light receiving sections. Here, the other three light transmitting sections do not transmit any transmission optical signal. As shown in (b) of FIG. 3, the transmission optical signal propagates through the space and thereafter, is received as a reception optical signal by each of the light receiving sections. For example, when only the first light transmitting section transmits the transmission optical signal to each of the light receiving sections (refer to a column indicated by a heavy-line frame in FIG. 3), the first light receiving section receives the reception optical signal with a received light intensity of “1.0”, the second light receiving section receives the reception optical signal with a received light intensity of “0.4”, the third light receiving section receives the reception optical signal with a received light intensity of “0.2”, the fourth light receiving section receives the reception optical signal with a received light intensity of “0.1”. As described above, in principle, the first light receiving section which is closest to the first light transmitting section receives the transmission optical signal transmitted by the first light transmitting section with the greatest received light intensity. The received light intensity of the transmission optical signal decreases in accordance with an increase in a distance from the first light transmitting section to each of the other light receiving sections. In a case where due to presence of an obstacle or the like in the space through which the transmission optical signal propagates, it is not recognized that the space is uniform, the first light receiving section which is closest to the first light transmitting section does not always receives the transmission optical signal transmitted by the first light transmitting section with the greatest received light intensity. Here, the values in (b) of FIG. 3 are shown with reference to the received light intensity of “1.0” with which the light receiving section receives the transmission optical signal and which is the greatest one. The first calculating section 130 determines the transfer factors such that the values of the transmission optical signal and the respective reception optical signals are the same as one another. Performing this process for each of the light transmitting sections allows the first calculating section 130 to determine all of the transfer factors. As described above, even in a case where three or more light transmitting sections and three or more light receiving sections are used, the transmission path measurement can be conducted as similarly to in a case where two light transmitting sections and two light receiving sections are used.

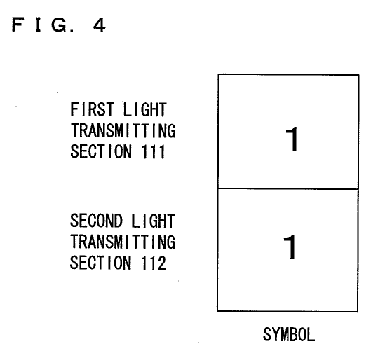

In addition, the optical space transmission system using the receiver apparatus according to the present invention has a feature that prior to starting the communications, the below-described optical beat interference component measurement is conducted. FIG. 4 is a diagram showing conditions under which the optical beat interference component measurement in a case where two light transmitting sections and two light receiving sections are used is conducted. As shown in FIG. 4, the first light transmitting section 111 converts a transmission electrical signal t1, whose value is “1”, to a transmission optical signal T1 and transmits the transmission optical signal T1 to the first light receiving section 121 and the second light receiving section 122. Concurrently with this, the second light transmitting section 112 converts a transmission electrical signal t2, whose value is “1”, to a transmission optical signal T2 and transmits the transmission optical signal T2 to the first light receiving section 121 and the second light receiving section 122. The transmission optical signals T1 and T2 propagate through the space and thereafter, are concurrently received as a reception optical signal R1 by the first light receiving section 121; and the transmission optical signals T1 and T2 propagate through the space and thereafter, are concurrently received as a reception optical signal R2 by the second light receiving section 122. By performing squared detection, the first light receiving section 121 converts the reception optical signal R1 to a reception electrical signal r1 and outputs the reception electrical signal r1. Similarly, by performing the squared detection, the second light receiving section 122 converts the reception optical signal R2 to a reception electrical signal r2 and outputs the reception electrical signal r2 (refer to FIG. 1). Here, as shown by the equation (12), the reception electrical signal r1 contains an optical beat interference component n1 and the reception electrical signal r2 contains an optical beat interference component n2. In the equation (12), each of values of the transmission electrical signals t1 and t2 is “1”. Because the transfer factors h11, h12, h21, and h22 have been determined by conducting the above-described transmission path measurement, values of a matrix having elements k11, k12, k21, and k22 are also determined (refer to the equation (8) and the equation (9)). This allows the second calculating section 140 to measure the optical beat interference components n1 and n2 by using the reception electrical signals r1 and r2 (refer to the equation (12)). Prior to starting the communications, the second calculating section 140 retains the measured optical beat interference components n1 and n2.

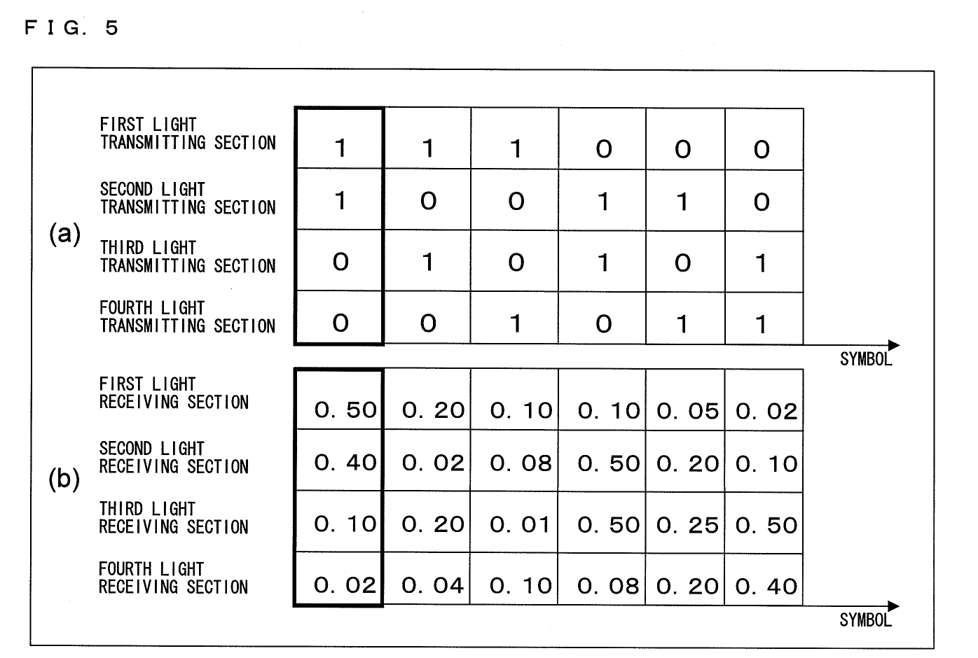

As conditions under which the optical beat interference component measurement is conducted and as received light intensities of respective light receiving sections in a case where three or more light transmitting sections and three or more light receiving sections are used, for illustrative purposes, conditions under which the optical beat interference component measurement is conducted and received light intensities of respective light receiving sections in a case where four light transmitting sections and four light receiving sections are used are shown in FIG. 5. As shown in (a) of FIG. 5, any two light transmitting sections convert transmission electrical signals, whose values are each “1”, to transmission optical signals and concurrently transmit the transmission optical signals to the respective light receiving sections. Here, the other light transmitting sections do not transmit the transmission electrical signals. The respective light receiving sections receives reception optical signals which have propagated through the space. Similarly, the respective light receiving sections receive reception optical signals in cases of all combinations (six combinations) of the light transmitting sections shown in (a) of FIG. 5 (refer to (b) of FIG. 5). For example, in a case where the first light transmitting section and the second light transmitting section concurrently transmit transmission optical signals to the respective light receiving sections (refer to a column indicated by a heavy-line frame in FIG. 5), the first light receiving section receives the reception optical signal with a received light intensity of “0.50”, the second light receiving section receives the reception optical signal with a received light intensity of “0.40”, the third light receiving section receives the reception optical signal with a received light intensity of “0.10”, the fourth light receiving section receives the reception optical signal with a received light intensity of “0.02”. Here, as described with reference to FIG. 3, the transfer factors in a case where the four light transmitting sections and the four light receiving sections are used have already been determined. This allows the second calculating section 140 to measure the optical beat interference components in all combinations (six combinations) of the light transmitting sections by using the reception electrical signals (refer to the equation (12)). As described above, even in a case where three or more light transmitting sections and three or more light receiving sections are used, optical beat interference component measurement can be conducted as similarly to in a case where two light transmitting sections and two light receiving sections are used. The above-described optical beat interference components in a case where three or more light transmitting section convert transmission electrical signals, whose values are each “1”, to transmission optical signals and concurrently transmit the transmission optical signals to the respective light receiving sections can be measured by overlapping the optical beat interference components measured by performing the above-described optical beat interference component measurement.

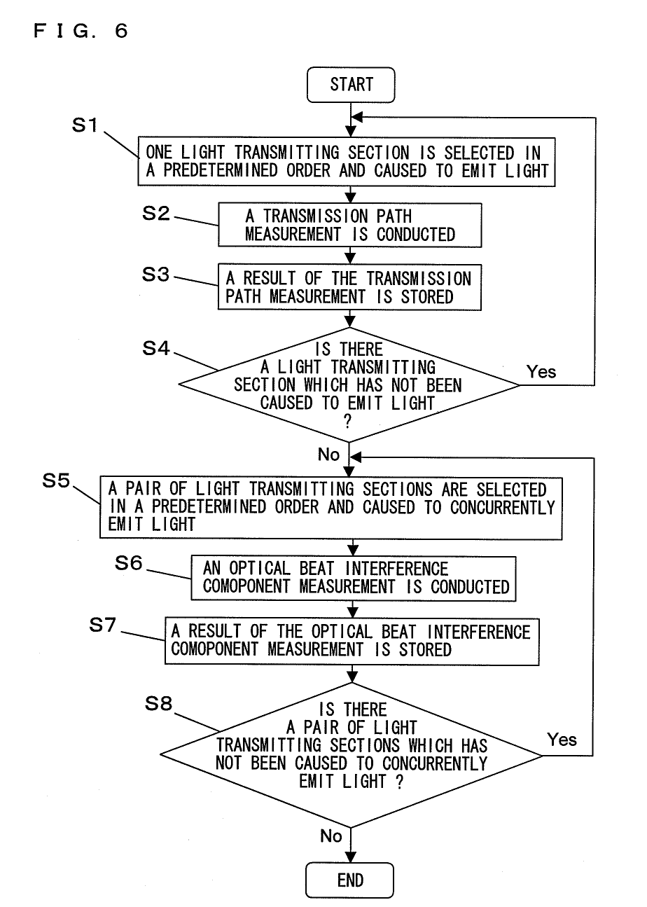

FIG. 6 is a flow chart showing the transmission path measurement and the optical beat interference component measurement. With reference to FIG. 6, a flow of the transmission path measurement and the optical beat interference component measurement in a case where two or more light transmitting sections and two or more light receiving sections are used will be briefly described. First, as described in detail with reference to FIG. 2 and FIG. 3, the transmitter apparatus selects each one of the light transmitting sections in a predetermined order and causes the selected one to emit light (step S1). Next, the receiver apparatus conducts the transmission path measurement (step S2). Next, the receiver apparatus stores a result (transfer factor) of the transmission path measurement (step S3). Next, the transmitter apparatus determines whether or not there is a light transmitting section which has not been caused to emit light (step S4). When there is a light transmitting section which has not been caused to emit light, the transmitter apparatus returns to step S1. When there is not a light transmitting section which has not been caused to emit light, the transmitter apparatus selects each one pair of light transmitting sections in a predetermined order and causes the pair to concurrently emit light as described in detail with reference to FIG. 4 and FIG. 5 (step S5). Next, the receiver apparatus conducts the optical beat interference component measurement (step S6). Next, the receiver apparatus stores a result of the optical beat interference component measurement (step S7). Next, the transmitter apparatus determines whether or not there is a pair of light transmitting sections which has not been caused to concurrently emit light (step S8). When there is the pair of light transmitting sections which has not been caused to concurrently emit light, the transmitter apparatus returns to step S5. When there is not the pair of light transmitting sections which has not been caused to concurrently emit light, the transmission path measurement and the optical beat interference component measurement are finished. After the above-described transmission path measurement and optical beat interference component measurement have been conducted, communications between the transmitter apparatus and the receiver apparatus are started.

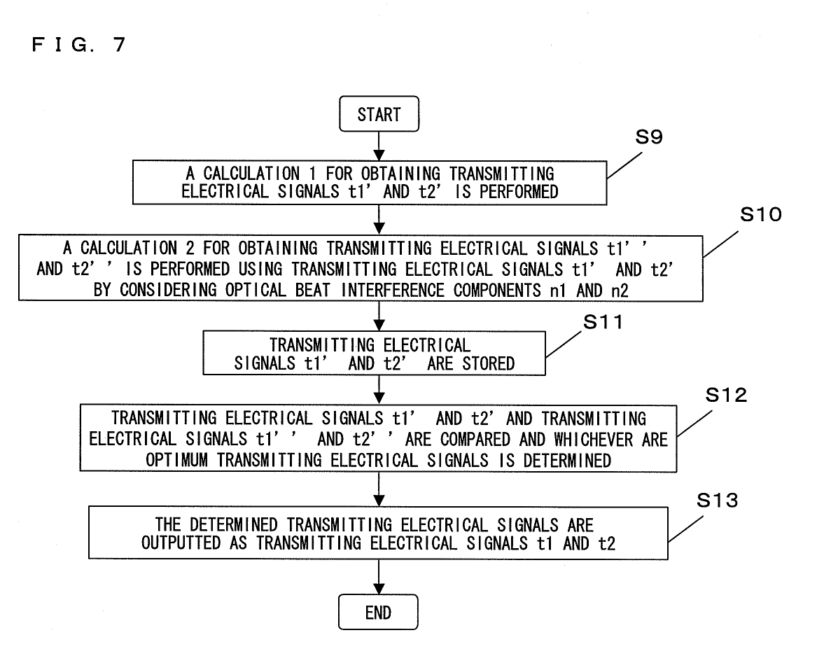

FIG. 7 is a flow chart showing operations performed when the receiver apparatus according to the embodiment of the present invention cancels the spatial overlaps of transmitted optical signals and the optical beat interference components. Hereinafter, a case where two light transmitting sections and two light receiving sections are used will be described. As shown in FIG. 7, by using the retained values of transfer factors h11, h12, h21, and h22 and the inputted reception electrical signals r1 and r2, the first calculating section 130 performs the calculation 1 (refer to the equation (8) through the equation (13)) for calculating transmission electrical signals t1′ and t2′ which are values for which any influences of the optical beat interference components n1 and n2 are not considered (step S9). In other words, by performing the calculation 1, the spatial overlaps of the transmitted optical signals are canceled. Here, as already described, when the optical beat interference components n1 and n2 do not occur, the transmission electrical signal t1′ is equal to the transmission electrical signal t1 and the transmission electrical signal t2′ is equal to the transmission electrical signal t2 (refer to the equation (13)). When the optical beat interference components n1 and n2 occur, because the optical beat interference components n1 and n2 cannot be canceled by performed the calculation 1 (refer to the equation (8) through the equation (13)), the transmission electrical signals t1 and t2 cannot be calculated. The first calculating section 130 outputs the transmission electrical signals t1′ and t2′ to the second calculating section 140 (refer to FIG. 1).

Next, the second calculating section 140 receives the transmission electrical signals t1′ and t2′ from the first calculating section 130. With respect to the transmission electrical signals t1′ and t2′, the second calculating section 140 performs the calculation 2 (refer to the equation (13)) for calculating the transmission electrical signals t1″ and t2″ by considering the values of retained optical beat interference components n1 and n2 (step S10). Here, when the optical beat interference components n1 and n2 occur, the transmission electrical signal t1″ is equal to the transmission electrical signal t1 and the transmission electrical signal t2″ is equal to the transmission electrical signal t2. When the optical beat interference components n1 and n2 do not occur, the transmission electrical signal t1″ is different from the transmission electrical signal t1 and the transmission electrical signal t2″ is different from the transmission electrical signal t2 (refer to the equation (13)). Next, the second calculating section 140 stores the inputted transmission electrical signals t1′ and t2′ (step S11). Note that step S10 and step S11 may be performed in reverse order. Next, the second calculating section 140 compares t1″ and t2″ obtained by performing the calculation 2 with t1′ and t2′ and determines, as the transmission electrical signals t1 and t2, whichever are optimum (step S12). The second calculating section 140 outputs the transmission electrical signals t1 and t2 (step S13). As described above, the receiver apparatus according to the embodiment of the present invention is capable of canceling the spatial overlaps of the transmitted optical signals and the optical beat interference components.

Operations performed when the receiver apparatus of the present invention cancels the spatial overlaps of the transmitted optical signals and the optical beat interference components in a case where three or more light transmitting section and three or more light receiving section are used will be described with reference to FIG. 7. As shown in FIG. 7, by using the retained transfer factors obtained by conducting the transmission path measurement, the first calculating section 130 calculates transmission electrical signals t1′ through tm′ (m is an integer equal to or greater than 3) by performing the calculation 1 (step S9). The first calculating section 130 outputs the transmission electrical signals t1′ through tm′ to the second calculating section 140.

Next, the second calculating section 140 receives the transmission electrical signals t1′ through tm′ from the first calculating section 130. With respect to the transmission electrical signals t1′ through tm′, the second calculating section 140 performs the calculation 2 for calculating the transmission electrical signals t1″ through tm″ by considering the values of the optical beat interference components n1 through nm which the second calculating section 140 has obtained by conducting the optical beat interference component measurement and has retained (step S10). Here, as already described, in a case where at least two or more light transmitting sections concurrently emit the transmission electrical signals, the optical beat interference components n1 through nm occur. Since there occur a plurality of combinations of optical beat interference components n1 through nm, which each vary depending on the light transmitting sections emitting the transmission electrical signals, the plurality of combinations of the optical beat interference components n1 through nm are measured. Specifically, the second calculating section 140 calculates the transmission electrical signal t1″ through tm″ by performing the calculation 2 with respect to each of the above-mentioned plurality of the optical beat interference components n1 through nm. Next, the second calculating section 140 stores the transmission electrical signals t1′ through tm′ (step S11). Note that step S10 and step S11 may be performed in reverse order. The second calculating section 140 selects one optimum combination, as the transmission electrical signals t1 through tm, from among the plurality of combinations of the transmission electrical signals t1″ through tm″ which have been obtained by performing the calculation 2 and one combination of the transmission electrical signals t1′ through t4′ (step S12). The second calculating section 140 outputs the transmission electrical signals t1 through tm (step S13). As described above, the receiver apparatus according to the embodiment of the present invention is capable of canceling the spatial overlaps of the transmitted optical signals and the optical beat interference components even in a case where three or more light transmitting sections and three or more light receiving sections are used.

Here, the optical beat interference components have the properties that the optical beat interference components occur when polarization directions of two optical signals transmitted from the light transmitting sections coincide with each other and that the optical beat interference components decrease in accordance with an increase in a deviation between the polarization directions of the two optical signals. Therefore, directions of polarized waves of the optical signals transmitted from the light transmitting sections are orthogonalized. In addition, when it is confirmed on the end of the receiver apparatus 150 that only the optical beat interference components having values, each of which is less than or equal to a predetermined permissible value, it is not necessary for the second calculating section 140 to perform the process for canceling the distortion caused by the optical beat interference. Accordingly, prior to performing the process for canceling the distortion caused by the optical beat interference, the second calculating section 140 calculates whether or not each of the values of the optical beat interference components which have occurred is only less than or equal to the predetermined permissible value. Only when each of the values of the optical beat interference components which have occurred is not less than or equal to the predetermined permissible value, the second calculating section 140 may perform the process for canceling the distortion caused by the optical beat interference. When each of the values of the optical beat interference components which have occurred is less than or equal to the predetermined permissible value, the second calculating section 140 may perform no process for canceling the distortion caused by the optical beat interference.

As described above, the receiver apparatus according to the embodiment of the present invention performs the calculation 1 and if needed, the calculation 2, by considering the values obtained through the transmission path measurement and the optical beat interference component measurement which are conducted prior to starting the communications, thereby obtaining the transmission electrical signals. This allows the receiver apparatus to cancel the spatial overlaps of the respective optical signals transmitted through the space and further, to cancel the optical beat interference components if needed. As a result, high quality transmission performance can be attained.

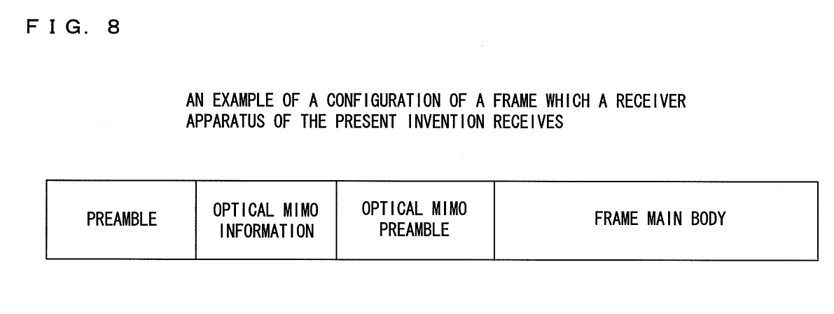

In the above description, it is described that when the transmission path measurement and the optical beat interference component measurement are conducted, the receiver apparatus has retained the order in which the light transmitting sections in the transmitter apparatus are caused to emit light. The order of the emission is notified to the receiver apparatus by using, for example, a frame shown in FIG. 8. FIG. 8 is a diagram showing an example of a configuration of a frame which the receiver apparatus according to the embodiment of the present invention receives. In the frame shown in FIG. 8, a preamble is a fixed pattern signal generally used for establishing synchronization; optical MIMO information is information or the like for controlling optical MIMO, indicating a transmission speed or the like; an optical MIMO preamble is a preamble signal used for an optical MIMO channel measurement; and a frame main body is a received data signal or the like. The preamble signal used for the optical MIMO channel measurement is a signal or the like, which is notified to the receiver apparatus for conducting the transmission path measurement and the optical beat interference component measurement, indicating the order in which the light transmitting sections are caused to emit light.

In addition, although in this embodiment, the case of the binary digital signal is described, the present invention is applied in a case of a different signal format, instead of the binary digital signal, such as a multilevel digital signal or the like.

Further, in a case of a sub-carrier transmission using a carrier wave and in a case where a small amount of electrical current for driving light sources is applied, optical signals are invariably emitted from all light transmitting sections. In this case, since optical beat interference components are invariably present, a measurement with respect to optical beat interference components is conducted in a case where a zero light transmitting section transmits a transmission optical signal and where one light transmitting section transmits a transmission optical signal. With respect to each of optical beat interference components including the optical beat interference components in the case where the zero light transmitting section transmits the transmission optical signal and the one light transmitting section transmits the transmission optical signal, the calculation 2 is performed. From among the calculated plurality of combinations of transmission electrical signals t1″ through tm″, one optimum combination may be selected as transmission electrical signal t1 through tm. However, in a case where an influence of chirp caused when an optical frequency modulation is performed is great, as similarly to in a case of a digital signal, prior to starting communication, it is only required to measure an optical beat interference component per transmitted signal component.

Furthermore, the values obtained through the transmission path measurement have been stored in a rewritable memory, whereby the first calculating section 130 is capable of reproducing transmission electrical signals in a high-quality manner in a specific state of a transmission path without redoing the transmission path measurement. Similarly, the values obtained through the optical beat interference component measurement have been stored in a rewritable memory, whereby the second calculating section 140 is capable of reproducing transmission electrical signals in a high-quality manner in a specific state of a transmission path without redoing the optical beat interference component measurement. Although in the above descriptions, cases where the two light transmitting sections and the two light receiving sections are used and where the four light transmitting sections and the four light receiving sections are used are described, the number of light transmitting sections and the number of light receiving sections are not limited thereto. One calculating section including the first calculating section and the second calculating section may be used.

### INDUSTRIAL APPLICABILITY

The present invention is applicable to a receiver apparatus or the like for use in an optical space transmission, which comprises a plurality of light receiving sections. In particular, the present invention is useful when it is desired to attain high-quality transmission performance by canceling spatial overlaps of transmitted optical signals and optical beat interference components.

1. A receiver apparatus, for use in an optical space transmission, operable to receive a plurality of optical signals which are converted from a plurality of transmission electrical signals and emitted through space, the receiver apparatus comprising:
a plurality of light receiving sections for receiving the plurality of optical signals and respectively converting the received plurality of optical signals to a plurality of electrical signals;
a first calculating section for subjecting the plurality of electrical signals to a process of canceling interference components occurring due to propagation of the plurality of optical signals through the space; and
a second calculating section for calculating, with respect to each of the plurality of electrical signals whose interference components have been canceled by the first calculating section, whether or not a value of a distortion occurring due to optical beat interference is less than or equal to a predetermined permissible value.

2. The receiver apparatus, for use in an optical space transmission, according to claim 1,
wherein when the value of the distortion occurring due to the optical beat interference is not less than or equal to the predetermined permissible value, the second calculating section further subjects each of the plurality of electrical signals, whose interference components have been canceled by the first calculating section, to a process of canceling the distortion occurring due to the optical beat interference.

3. The receiver apparatus, for use in an optical space transmission, according to claim 2,
wherein the second calculating section selects one optimum combination of a plurality of electrical signals from among one combination of the plurality of electrical signals obtained when the plurality of electrical signals are subjected to the process by the first calculating section and a plurality of combinations of a plurality of electrical signals obtained when the plurality of electrical signals obtained when the plurality of electrical signals are subjected to the process by the first calculating section are subjected to the process by the second calculating section and determines the one optimum combination of the plurality of electrical signals as the plurality of transmission electrical signals.

4. The receiver apparatus, for use in an optical space transmission, according to claim 2,
wherein the first calculating section cancels the interference components occurring due to the propagation by using propagation factors obtained by conducting a transmission path measurement, and
wherein the second calculating section cancels the distortion each occurring due to the optical beat interference by using values of optical beat interference components, which have been obtained by conducting an optical beat interference component measurement.

5. The receiver apparatus, for use in an optical space transmission, according to claim 4,
wherein the optical beat interference components are measured by performing, for all combinations of a pair of the light transmitting sections, an operation in which the plurality of the light receiving sections receive optical signals concurrently transmitted by any pair of the light transmitting sections among the plurality of light transmitting sections for transmitting the plurality of optical signals.

6. The receiver apparatus, for use in an optical space transmission, according to claim 1,
wherein polarized waves of each two adjacent optical signals of the plurality of optical signals converted from the plurality of transmission electrical signals are orthogonalized, and
wherein when the value of the distortion occurring due to the optical beat interference is less than or equal to the predetermined permissible value, the second calculating section outputs, as the plurality of transmission electrical signals, the plurality of electrical signals whose interference components have been canceled by the first calculating section.

7. A reception method for use in an optical space transmission, in which a plurality of optical signals converted from a plurality of transmission electrical signals and emitted through space, are received, the method comprising the steps of:
receiving the plurality of optical signals and respectively converting the received optical signals to a plurality of electrical signals;
canceling, with respect to the plurality of electrical signals, interference components occurring due to propagation of the plurality of optical signals through the space; and
calculating, with respect to each of the plurality of electrical signals whose interference components have been canceled by the first calculating section, whether or not a value of a distortion occurring due to optical beat interference is less than or equal to a predetermined permissible value.

8. The reception method, for use in an optical space transmission, according to claim 7, the method further comprising the step of,
when the value of the distortion occurring due to the optical beat interference is not less than or equal to the predetermined permissible value, subjecting each of the plurality of electrical signals, whose interference components have been canceled, to a process of canceling the distortion occurring due to the optical beat interference.

9. The reception method, for use in an optical space transmission, according to claim 8, the method further comprising the step of,
selecting one optimum combination of a plurality of electrical signals from among one combination of the plurality of electrical signals obtained when the plurality of electrical signals are subjected to the process by the first calculating section and a plurality of combinations of a plurality of electrical signals obtained when the plurality of electrical signals obtained when the plurality of electrical signals are subjected to the process by the first calculating section are subjected to the process by the second calculating section and determines the one optimum combination of the plurality of electrical signals as the plurality of transmission electrical signals.

10. The reception method, for use in an optical space transmission, according to claim 8,
wherein at the step of canceling the interference components occurring due to the propagation, values of propagation factors, which have been obtained by conducting a transmission path measurement, are used, and
wherein at the step of canceling the distortion occurring due to the optical beat interference, values of optical beat interference components, which have been obtained by conducting a optical beat interference component measurement, are used.

11. The reception method, for use in an optical space transmission, according to claim 10,
wherein the optical beat interference components are measured by performing, for all combinations of a pair of the light transmitting sections, an operation in which the plurality of the light receiving sections receive optical signals concurrently transmitted by any pair of the light transmitting sections among the plurality of light transmitting sections for transmitting the plurality of optical signals.

12. The reception method, for use in an optical space transmission, according to claim 7,
wherein polarized waves of each two adjacent optical signals of the plurality of optical signals converted from the plurality of transmission electrical signals are orthogonalized, and
wherein when the value of the distortion occurring due to the optical beat interference is less than or equal to the predetermined permissible value, the plurality of electrical signals whose interference components occurring due to the propagation have been canceled are outputted as the plurality of transmission electrical signals.

13. A program executed by a receiver apparatus, for use in an optical space transmission, operable to receive a plurality of optical signals which are converted from a plurality of transmission electrical signals and emitted through space, the program comprising the steps of:
receiving the plurality of optical signals and respectively converting the received plurality of optical signals to a plurality of electrical signals;
subjecting the plurality of electrical signals to a process of canceling interference components occurring due to propagation of the plurality of optical signals through the space; and
calculating, with respect to each of the plurality of electrical signals whose interference components have been canceled by the first calculating section, whether or not a value of a distortion occurring due to optical beat interference is less than or equal to a predetermined permissible value.
